(19) United States
(12) Patent Application Publication
(10) Pub. No.: US 2017/0003803 A1
(43) Pub. Date: Jan. 5, 2017

(54) TOUCH DISPLAY SYSTEM, IMAGE PROCESSING DEVICE, TOUCH DISPLAY METHOD, AND IMAGE PROCESSING METHOD

(71) Applicant: Coretronic Corporation, Hsin-Chu (TW)

(72) Inventors: Yung-Chih Chen, Hsin-Chu (TW); Chi-Hsun Huang, Hsin-Chu (TW)

(21) Appl. No.: 15/163,695

(22) Filed: May 25, 2016

(30) Foreign Application Priority Data
Jun. 30, 2015 (CN) 201510385388.6

(51) Int. Cl. G06F 3/041; G06T 11/60

(52) U.S. Cl. CPC G06F 3/0416; G06F 3/0412; G06T 11/60

(57) ABSTRACT

The invention provides a touch display system, an image processing device, a touch display method, and an image processing method. A touch image and an image provided by an image source are overlaid to generate a combined image to be displayed. In addition, the touch image includes a touch writing of an input tool on a touch area. The invention does not require a computer host for touch display. Therefore, the convenience of using the touch display system is consequently improved.

### CROSS-REFERENCE TO RELATED APPLICATION

This application claims the priority benefit of China application serial no. 201510385388.6, filed on Jun. 30, 2015. The entirety of the above-mentioned patent application is hereby incorporated by reference herein and made a part of this specification.

### BACKGROUND OF THE INVENTION

Field of the Invention

The invention relates to an electronic device. More specifically, the invention relates to a touch display system, an image processing device, a touch display method, and an image processing method.

Description of Related Art

As electronic devices are being developed to incorporate multiple functions, the conventional push-button interface can no longer satisfy the user's needs. Under such circumstance, the development of interactive touch technology becomes more and more prosperous. Compared with the conventional push-button interface, the interactive touch interface is simpler and more intuitive. The user inputs with a touch on a display surface of an electronic device by directly using a finger or a touch pen.

In the conventional touch display, a touch point information is converted into a writing through a computer, and the writing is displayed as a displaying image. In this way, the user intuitively marks a text or an image on the image displayed by the computer. The data processing ability of the computer is used to process the touch point information, so that the touch point information and the display image are combined and output to a display device to be displayed. However, a DVD player that offers image data does not have such data processing ability. Thus, the user needs a computer if marking a text or an image on a display frame is intended, and such limitation causes inconvenience of the user.

The information disclosed in this “Description of Related Art” section is only for enhancing understanding of the background of the invention and therefore it may contain information that does not form the prior art that is already known to people having ordinary skills in the art. Furthermore, the information disclosed in this “Description of Related Art” section does not mean that the contents or one or more problems to be solved by one or more embodiments of the invention was acknowledged by people having ordinary skills in the art.

### SUMMARY OF THE INVENTION

The invention provides a touch display system, an image processing device, a touch display method, and an image processing method capable of offering a touch display function without a computer host, thereby improving the convenience of using the touch display system.

Other objects and advantages of the invention can be further illustrated by the technical features broadly embodied and described as follows.

To achieve one or part or all of the objectives or other objectives, an embodiment of the invention provides a touch display system including an image processing device and a display unit. The image processing device includes a first image processing unit, a second image processing unit, and a first image combining unit. The first image processing unit receives and transmits a touch image, and the touch image includes a touch writing of an input tool on a touch area. The second image processing unit receives and transmits a first image. The image combining unit receives and overlays the touch image and the first image to generate a first combined image. The display unit is coupled to the image processing device and displays a displaying image on the touch area according to the first combined image.

According to an embodiment of the touch display system of the invention, the touch display system further includes a touch image generating unit. The touch image generating unit is coupled to the first image processing unit, receives a touch position coordinate signal correspondingly generated when the input tool performs a touch operation on the touch area, and generates the touch image according to the touch position coordinate signal.

According to an embodiment of the touch display system of the invention, the touch display system further includes a touch unit. The touch unit is coupled to the touch image generating unit and detects a touch position of the input tool on the touch area, so as to generate the touch position coordinate signal.

According to an embodiment of the touch display system of the invention, the image processing device further includes a third image processing unit and a second image combining unit. The third image processing unit receives and transmits a second image. The second image combining unit overlays the first combined image and the second image to output a second combined image. The display unit further displays the displaying image on the touch area according to the second combined image.

According to an embodiment of the touch display system of the invention, the touch display system further includes a storage unit. The storage unit stores at least one of the first combined image and the second combined image.

An embodiment of the invention provides an image processing device, and the image processing device includes a first image processing unit, a second image processing unit, and a first image combining unit. The first image processing unit receives and transmits a touch image, and the touch image includes a touch writing of an input tool on a touch area. The second image processing unit receives and transmits a first image. The first image combining unit receives and overlays the touch image and the first image to generate a first combined image.

According to an embodiment of the image processing device of the invention, the image processing device further includes a touch image generating unit. The touch image generating unit is coupled to the first image processing unit, receives a touch position coordinate signal correspondingly generated when the input tool performs a touch operation on the touch area, and generates the touch image according to the touch position coordinate signal.

According to an embodiment of the image processing device of the invention, the image processing device further includes a third image processing unit and a second image combining unit. The third image processing unit receives and transmits a second image. The second image combining unit overlays the first combined image and the second image to output a second combined image.

According to an embodiment of the image processing device of the invention, the image processing device further includes a storage unit. The storage unit stores at least one of the first combined image and the second combined image.

An embodiment of the invention provides a touch display method, including the following steps. Firstly, a first image processing unit is provided. The first image processing unit is configured to receive and transmit a touch image, and the touch image includes a touch writing of an input tool on a touch area. Then, a second image processing unit is provided. The second image processing unit is configured to receive and transmit a first image. Afterwards, a first image combining unit is provided. The first image combining unit is configured to receive and overlay the touch image and the first image, and generate a first combined image. Subsequently, a display unit is provided. The display unit is configured to display a displaying image on the touch area according to the first combined image.

According to an embodiment of the touch display method of the invention, the touch display method further includes detecting a touch position of the input tool on the touch area to generate a touch position coordinate signal and generating the touch image according to the touch position coordinate signal.

According to an embodiment of the touch display method of the invention, the touch display method further includes steps as follows. A third image processing unit is provided. The third image processing unit is configured to receive and transmit a second image. Then, a second image combining unit is provided. The second image combining unit is configured to overlay the first combined image and the second image and output a second combined image. Subsequently, the display unit is configured to display the displaying image on the touch area further according to the second combined image.

According to an embodiment of the touch display method of the invention, the touch display method further includes storing at least one of the first combined image and the second combined image.

An embodiment of the invention provides an image processing method, including the following steps. Firstly, a first image processing unit is provided. The first image processing unit is configured to receive and transmit a touch image, and the touch image includes a touch writing of an input tool on a touch area. Then, a second image processing unit is provided. The second image processing unit is configured to receive and transmit a first image. Afterwards, a first image combining unit is provided. The first image combining unit is configured to receive and overlay the touch image and the first image, and generate a first combined image.

According to an embodiment of the image processing method of the invention, the image processing method further includes steps as follows. When a touch operation on the touch area is performed by the input tool, a touch position coordinate signal correspondingly generated is received. The touch image is generated according to the touch position coordinate signal.

According to an embodiment of the image processing method of the invention, the image processing method further includes steps as follows. A third image processing unit is provided. The third image processing unit is configured to receive and transmit a second image. Then, a second image combining unit is provided. The second image combining unit is configured to overlay the first combined image and the second image and output a second combined image.

According to an embodiment of the image processing method of the invention, the touch image processing method further includes storing at least one of the first combined image and the second combined image.

According to above, in the embodiments of the invention, the touch image and the image provided by an image source are overlaid, so as to generate the combined image to be displayed. In addition, the touch image may include the touch writing of the input tool on the touch area. In this way, by simply overlaying the images, the touch writing is displayed on the displaying image without using a computer. Consequently, the convenience of using the touch display system is improved.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a schematic view illustrating an image processing device according to an embodiment of the invention.

FIG. 2 is a schematic view illustrating a touch display system according to an embodiment of the invention.

FIGS. 3A and 3B are schematic views illustrating touch display systems according to other two embodiments of the invention.

FIG. 4 is a flowchart illustrating an image processing method according to an embodiment of the invention.

FIG. 5 is a flowchart illustrating a touch display method according to an embodiment of the invention.

FIG. 6 is a flowchart illustrating a touch display method according to another embodiment of the invention.

### DESCRIPTION OF THE EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

FIG. 1 is a schematic view illustrating an image processing device according to an embodiment of the invention. Referring to FIG. 1, an image processing device 100 includes a first image processing unit 102, a second image processing unit 104, and a first image combining unit 106. In addition, the first image combining unit 106 is coupled to the first image processing unit 102 and the second image processing unit 104. The first image processing unit 102 receives and transmits a touch image ST1. In addition, the touch image ST1 includes a touch writing of an input tool on a touch area. In the embodiment, the input tool may be a finger or a touch pen, for example. However, the invention is not limited thereto. The touch area may be a touch display surface of a touch display panel or a touch surface of an electronic whiteboard, for example. However, the invention is not limited thereto. The second image processing unit 104 may receive and transmit an image SD1. The image SD1 may be image data provided by any image source, such as a DVD player, a mobile phone, a computer, etc., which provide display data or display images. In addition, the first image combining unit 106 may receive and overlay the touch image ST1 and the image SD1 to generate a combined image SC1.

In the embodiment, the image processing device 100 is a set-top box, for example. Thus, in the embodiment, the image processing device 100 may be directly connected to the image source (not shown) and a touch writing generating source (not shown) to respectively receive the image SD1 and the touch image ST1 without using a computer, so as to generate the combined image SC1 to be displayed afterwards by a display. However, the invention does not intend to limit the image processing device to be a set-top box. The image processing device 100 may have different configurations or be used in different electronic systems according to various needs.

In the embodiment, the first image processing unit 102 and the second image processing unit 104 may respectively scale (e.g. magnify or minify) the touch image ST1 and the image SD1. More specifically, with the user setting a scaling ratio to the image(s) (i.e. the image SD1 and/or the touch image ST1) to be displayed, the first image processing unit 102 and/or the second image processing unit 104 may correspondingly scale the touch image ST1 and/or the image SD1 according to the setting of the scaling ratio. Then, the first image combining unit 106 may receive and synthesize the scaled touch image ST1 and/or image SD1.

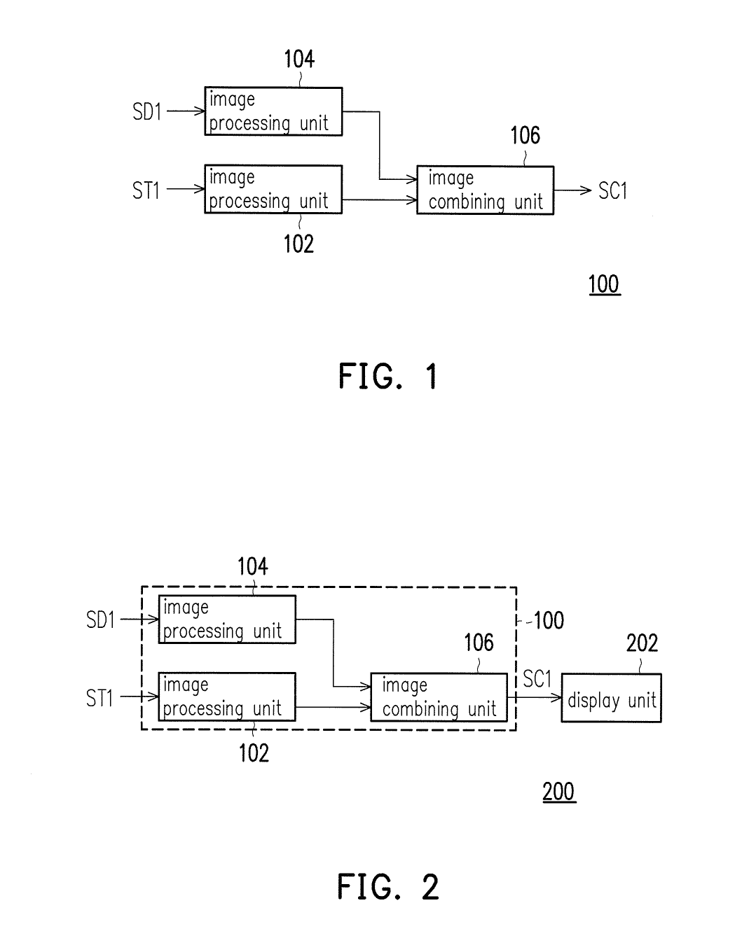

In addition, the image processing device 100 shown in the embodiment of FIG. 1 may be used in a touch display system having a touch function. FIG. 2 is a schematic view illustrating a touch display system according to an embodiment of the invention. Referring to FIG. 2, a touch display system 200 of the embodiment includes the image processing device 100 of the embodiment of FIG. 1 and a display unit 202. The display unit 202 is coupled to the image processing device 100. More specifically, the combined image SC1 is provided to the display unit 202 to be displayed. The display unit 202 may display a displaying image on the touch area according to the combined image SC1. The displaying image includes the image SD1 and the touch image ST1 (e.g., the touch writing of the input tool on the touch area) overlaid on the image SDI. In the embodiment, the display unit 202 may be a projector, for example. However, the invention is not limited thereto. In another embodiment, the display unit 202 may also be implemented as a liquid crystal display. Under the circumstance that the display unit 202 is a projector, the touch area may be a complete area or a partial area of a projection image on the electronic whiteboard. In other embodiments, the display unit 202 may be a touch display panel, for example. Under such circumstance, the touch area may be a complete area or a partial area of a touch display image.

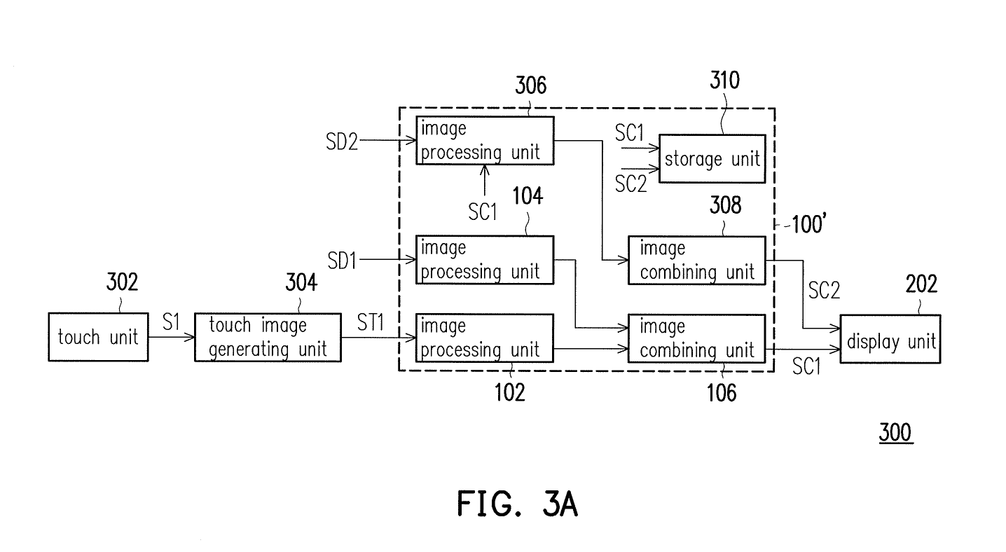

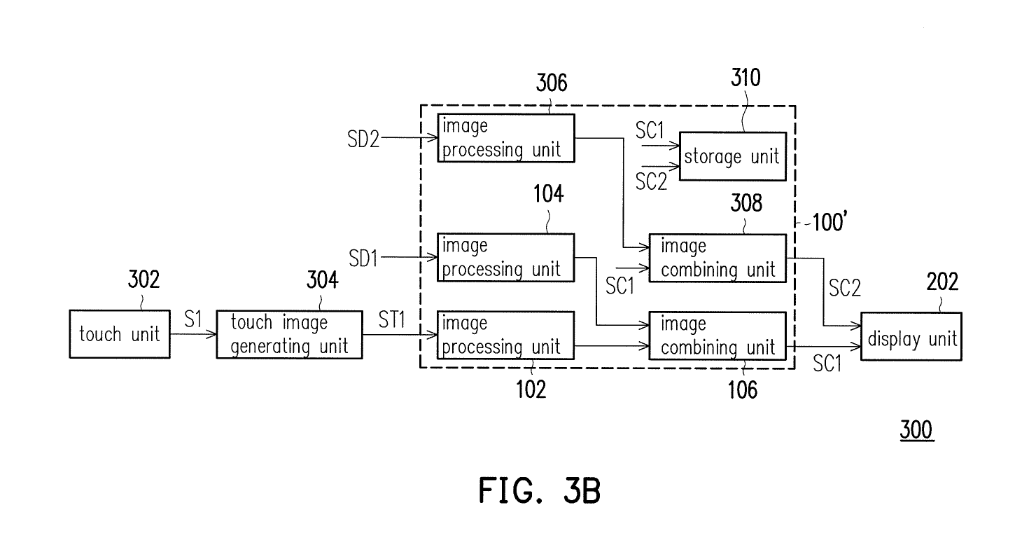

In the embodiment, the first image processing unit 102 and the second image processing unit 104 may be used to scale the touch image ST1 and the image SD1 or adjust gray levels or chrominance of the touch image ST1 and the image SD1, for example, so that the displaying image may exhibit a richer display effect. Specifically, as shown in FIG. 3A, a touch display system 300 of the embodiment may further include a touch unit 302 and a touch image generating unit 304. In addition, an image processing device 100′ of the embodiment may further include a third image processing unit 306, a second image combining unit 308, and a storage unit 310. However, the numbers of image processing units and image combining units in the image processing device 100′ may be added or reduced according to practical needs, and the invention is not limited to the above embodiments. The touch image generating unit 304 is coupled to the touch unit 302. In addition, the touch image generating unit 304 of the embodiment is coupled to the image processing device 100′ by being coupled to the first image processing unit 102, for example. In the embodiment, the display unit 202 is a projector, for example, the display unit 302 may be an electronic whiteboard, for example, and the touch area is a touch area on the electronic whiteboard. Accordingly, a touch writing may be generated by performing a touch operation on the touch area of the electronic whiteboard using the input tool (e.g., a finger or a touch pen). The touch image generating unit 304 may receive a touch position coordinate signal S1 correspondingly generated when the input tool performs a touch operation on the touch area, and converts the touch position coordinate signal S1 into the touch image ST1, so as to provide the touch image ST1 to the first image processing unit 102. In addition, according to the embodiments, the first image combining unit 106 may overlay the touch image ST1 and the image SD1, and transmit the combined image SC1 to the projector (i.e., the display unit 202 of the embodiment). In this way, the projector may project a displaying image formed by the touch image ST1 and the image SD1 overlaid on the touch area of the electronic whiteboard.

Besides, since the image processing device 100′ of the embodiment includes the third image processing unit 306 and the second image combining unit 308, the image processing device 100′ of the embodiment may receive an image SD2. In other words, the image processing device 100′ of the embodiment is capable of receiving multiple images SD1 and SD2. According to above, compared with the image processing device 100 of FIG. 2 having an image data input terminal for receiving the image SD1, the image processing device 100′ of FIG. 3A may have a plurality of image data input terminals for receiving the images SD1 and SD2. Besides, since the image processing device 100′ has the image combining units 106 and 106, the image processing device 100′ may output multiple combined images SC1 and SC2 by using a plurality of image data output channels. For example, in the embodiment, the third image processing unit 306 may receive the image SD2 and the combined image SC1 output by the first image combining unit 106, and transmit the image SD2 to the second image combining unit 308, such that the second image combining unit 308 overlays the combined image SC1 and the image SD2 to form the combined image SC2. In other words, the combined image SC2 may be formed by overlaying the image SD1, the image SD2, and the touch image ST1.

In some embodiments, the image processing units 102, 104, and 306 may scale images, and the image combining units 106 and 308 may further decide a display position of each of the scaled images after receiving the scaled images. Furthermore, with the user setting the scaling ratios and the display positions of the images to be displayed, the image processing units 102, 104, and 306 may scale the images to be displayed according to the setting of scaling ratios. When combining, the image combining units 106 and 308 may decide a position where each of the scaled images to be displayed is arranged according to the setting of display positions, such that the combined images SC1 and SC2 may demonstrate a picture-in-picture display effect or a split-screen display effect.

In the embodiment, the storage unit 310 may store at least one of the combined image SC1 and the combined image SC2 generated by the first image combining unit 106 and the second image combining unit 308. In some embodiments, the display unit 202 may include a multi-task unit or multiplexer. The multi-task unit/multiplexer may choose the combined image SC1 or the combined image SC2 as the image to be displayed. In other embodiments, the multi-task unit/multiplexer is not limited to be disposed in the display unit 202. For example, the multi-task unit/multiplexer may also be disposed in the image processing device 100′. Besides, in some embodiments, the first image combining unit 106 and the second image combining unit 308 may be respectively connected to different physical output terminals. In this way, the image processing device 100′ may be coupled to different display units at the same time, such that the different display units may respectively display the combined images SC1 and SC2.

However, targets to be combined by the image combining units 106 and 308 are not limited to the above embodiments, and may be determined according to the user's needs. For example, in some embodiments, the second image combining unit 308 may also combine/synthesize the images SD1 and SD2. Or, in other embodiments, as shown in FIG. 3B, the third image processing unit 306 initially only receives and processes the image SD2, and then the second image combining unit 308 receives the combined image SC1 and the processed image SD2 to generate the combined image SC2, for example. The image processing device 100′ described in FIGS. 3A-3B has three image processing units 102, 104, and 306 and two image combining units 106 and 308, for example. However, the invention is not limited thereto. For example, in some embodiments, the image processing device may have arbitrary/appropriate numbers of image processing units and image combining units according to the needs, and images after being processed (e.g., scaling, gray-level adjusting, chrominance adjusting, etc.,) by the image processing device may be transmitted to the arbitrary/appropriate image combining units according to the needs. In other words, the image combining unit may receive images provided by the arbitrary/appropriate image processing units according to the needs.

In addition, the invention does not intend to limit the touch image generating unit 304 and the image processing device 100/100′ in FIGS. 3A and 3B as being separate from each other. In other embodiments, the touch image generating unit 304 may also be built/embedded in the image processing device 100/100′. In other words, the image processing device 100/100′ and the touch image generating unit 304 may be integrated into one device for better convenience.

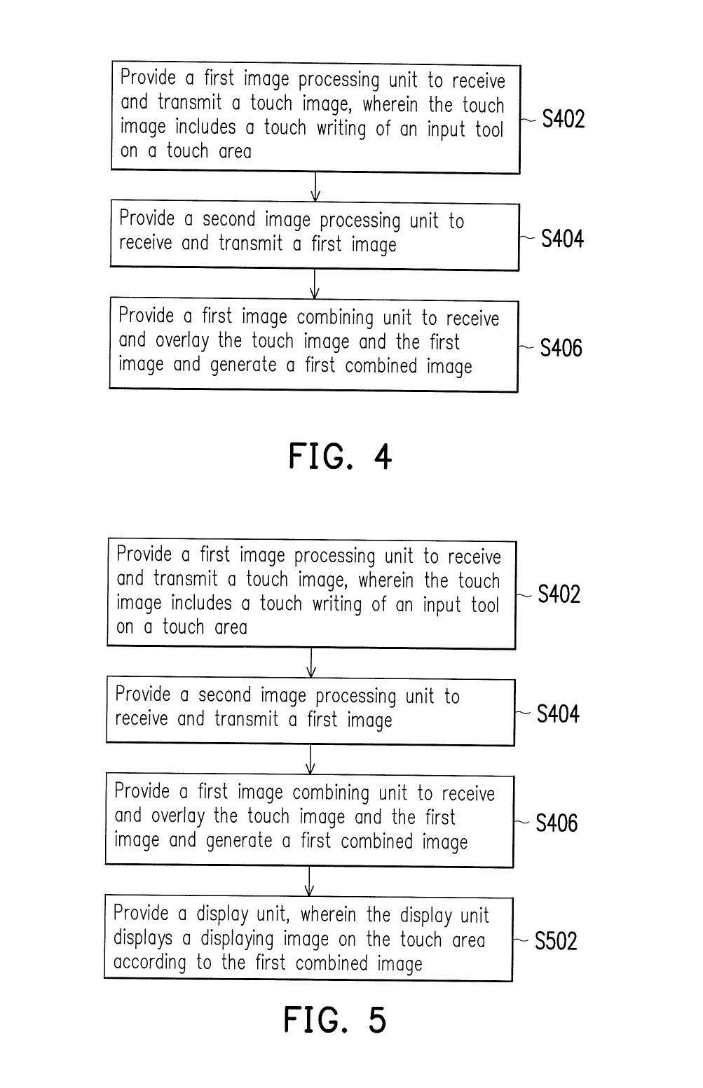

FIG. 4 is a flowchart illustrating an image processing method according to an embodiment of the invention. Referring to FIG. 4, according to the above embodiments, the processing method of the image processing device may include steps as follows. Firstly, the first image processing unit is provided to receive and transmit the touch image. In addition, the touch image includes the touch writing of the input tool on the touch area (Step S402). In an embodiment, the touch image may be generated according to the touch position coordinate signal, and the touch position coordinate signal is a signal correspondingly generated when the input tool performs a touch operation on the touch area. Then, the second image processing unit is provided to receive and transmit a first image (Step S404). Afterwards, the first image combining unit is provided to receive and overlay the touch image and the first image, and generate a first combined image (Step S406). In addition, in some embodiments, the number of combined images may be increased. For example, the third image processing unit and the second image combining unit may be provided. The third image processing unit is configured to receive and transmit a second image, and the second image combining unit is configured to overlay the first combined image and the second image to output a second combined image.

However, the embodiment of the invention may provide a touch display method according to the image processing method described in FIG. 4, as shown in FIG. 5. FIG. 5 is a flowchart illustrating a touch display method according to an embodiment of the invention. Referring to FIGS. 5 and 4, in FIG. 5, after Steps S402, S404, and S406 mentioned in FIG. 4 are performed, the display unit is provided, such that the display unit displays a displaying image on the touch area according to the first combined image (Step S502). In an embodiment, the touch area may be a touch area of an electronic whiteboard, for example, and the display unit may be a projector, for example.

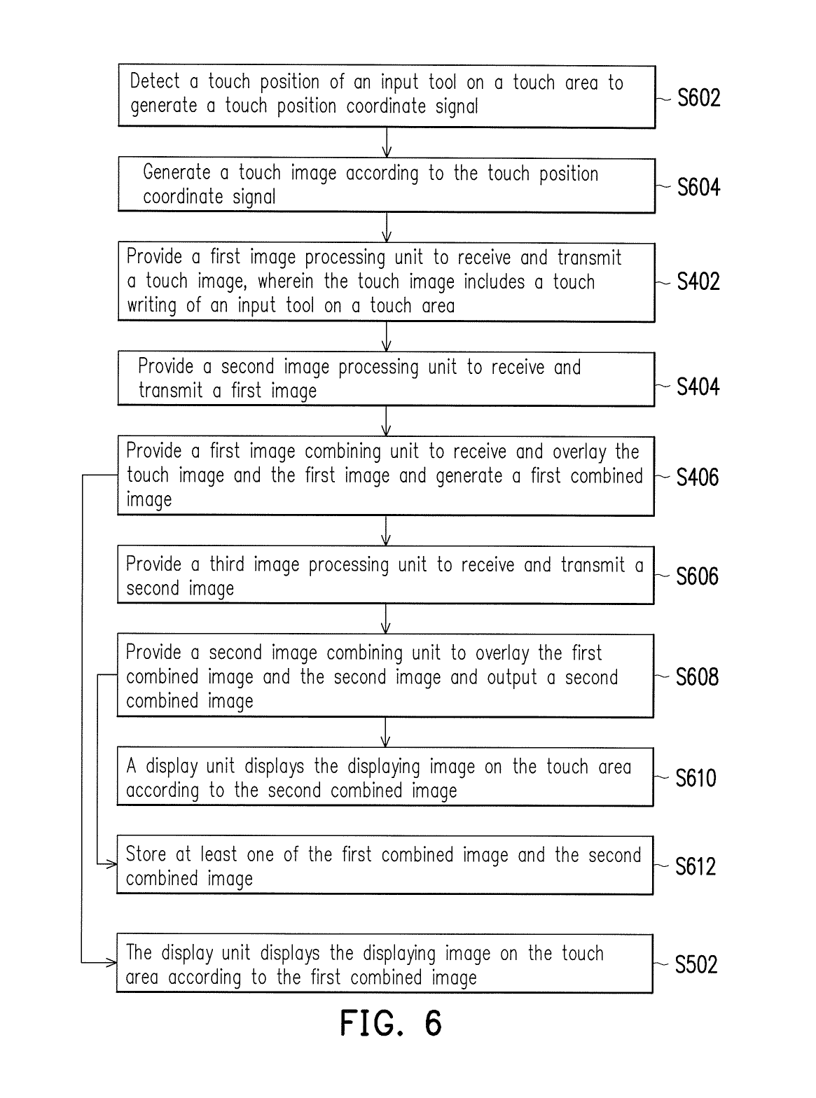

FIG. 6 is a flowchart illustrating a touch display method according to another embodiment of the invention. Referring to FIG. 6, according to the above embodiments, the touch display method of the touch display system may include steps as follows. Firstly, the touch position of the input tool on the touch area is detected to generate the touch position coordinate signal (Step S602). Then, the touch image is generated according to the touch position coordinate signal (Step S604). Afterwards, in an embodiment, Step S502 may be performed after performing Steps S402, S404, and S406, so as to perform subsequent actions according to the first combined image. Alternatively, in another embodiment, Step S612 may be carried out after performing Step S406, so as to store the first combined image. Besides, after Step S406, the third image processing unit may be provided to receive and transmit the second image (Step S606). Furthermore, the second image combining unit is provided to overlay the first combined image and the second image, and output the second combined image (Step S608). Moreover, the display unit displays a displaying image on the touch area according to the second combined image (Step S610). Besides, in some embodiment, Step S612 may be carried out after performing Step S608, so as to store the second combining image.

However, the invention is not limited to forms of the image processing unit, image combining unit, touch image generating unit, and storage unit of the above embodiments. For example, the image processing unit and the image combining unit in the above embodiments may be implemented in separate circuit designs or be implemented in a circuit design in one chip, such as IP00C732 and IP00C733 manufactured by iChip. However, the invention is not limited thereto. Besides, the touch image generating unit may be a common circuit design, an application-specific integrated circuit (ASIC), microcontroller unit (MCU), etc., in the field of touch technology. However, the invention is not limited thereto. The storage unit may be a built-in hard drive, a memory, or an external USB flash drive. However, the invention is not limited thereto. The invention does not intend to limit the image processing unit, the image combining unit, and the touch image generating unit as hardware or software components. Also, the storage unit in the embodiments may be a hardware component, and or implemented as a virtual storage, so as to achieve the needs of the actual product.

In view of the foregoing, in the embodiments of the invention, the touch image and the image provided by the image source are overlaid, so as to generate the combined image to be displayed. In addition, the touch image may include the touch writing of the input tool on the touch area. In this way, by simply overlaying the images, the touch writing is displayed on the displaying image without using a computer. Consequently, the convenience of using the touch display system is improved. In some embodiments, the images provided by multiple image sources may be overlaid with the touch image after being scaled. Thus, the displaying image may be displayed in a variety of ways.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A touch display system, comprising:
an image processing device, comprising:
a first image processing unit, receiving and transmitting a touch image, wherein the touch image comprises a touch writing of an input tool on a touch area;
a second image processing unit, receiving and transmitting a first image; and
a first image combining unit, receiving and overlaying the touch image and the first image to generate a first combined image; and
a display unit, coupled to the image processing device, and displaying a displaying image on the touch area according to the first combined image.

2. The touch display system as claimed in claim 1, further comprising:
a touch image generating unit, coupled to the first image processing unit, wherein the touch image generating unit receives a touch position coordinate signal correspondingly generated when the input tool performs a touch operation on the touch area, and generates the touch image according to the touch position coordinate signal.

3. The touch display system as claimed in claim 2, further comprising:
a touch unit, coupled to the touch image generating unit and detecting a touch position of the input tool on the touch area, so as to generate the touch position coordinate signal.

4. The touch display system as claimed in claim 1, wherein the image processing device further comprises:
a third image processing unit, receiving and transmitting a second image; and
a second image combining unit, overlaying the first combined image and the second image to output a second combined image, wherein the display unit further displays the displaying image on the touch area according to the second combined image.

5. The touch display system as claimed in claim 4, further comprising:
a storage unit, storing at least one of the first combined image and the second combined image.

6. An image processing device, comprising:
a first image processing unit, receiving and transmitting a touch image, wherein the touch image comprises a touch writing of an input tool on a touch area;
a second image processing unit, receiving and transmitting a first image; and
a first image combining unit, receiving and overlaying the touch image and the first image to generate a first combined image.

7. The image processing device as claimed in claim 6, further comprising:
a touch image generating unit, coupled to the first image processing unit, wherein the touch image generating unit receives a touch position coordinate signal correspondingly generated when the input tool performs a touch operation on the touch area, and generates the touch image according to the touch position coordinate signal.

8. The image processing device as claimed in claim 6, further comprising:
a third image processing unit, receiving and transmitting a second image; and
a second image combining unit, overlaying the first combined image and the second image to output a second combined image.

9. The image processing device as claimed in claim 8, further comprising:
a storage unit, storing at least one of the first combined image and the second combined image.

10. A touch display method, comprising:
providing a first image processing unit, wherein the first image processing unit is configured to receive and transmit a touch image, and the touch image comprises a touch writing of an input tool on a touch area;
providing a second image processing unit, wherein the second image processing unit is configured to receive and transmit a first image;
providing a first image combining unit, wherein the first image combining unit is configured to receive and overlay the touch image and the first image, and generate a first combined image; and
providing a display unit, wherein the display unit is configured to display a displaying image on the touch area according to the first combined image.

11. The touch display method as claimed in claim 10, further comprising:
detecting a touch position of the input tool on the touch area to generate a touch position coordinate signal; and
generating the touch image according to the touch position coordinate signal.

12. The touch display method as claimed in claim 10, further comprising:
providing a third image processing unit, wherein the third image processing unit is configured to receive and transmit a second image;
providing a second image combining unit, wherein the second image combining unit is configured to overlay the first combined image and the second image and output a second combined image; and
the display unit is configured to display the displaying image on the touch area further according to the second combined image.

13. The touch display method as claimed in claim 12, further comprising:
storing at least one of the first combined image and the second combined image.

14. An image processing method, comprising:
providing a first image processing unit, wherein the first image processing unit is configured to receive and transmit a touch image, and the touch image comprises a touch writing of an input tool on a touch area;
providing a second image processing unit, wherein the second image processing unit is configured to receive and transmit a first image; and
providing a first image combining unit, wherein the first image combining unit is configured to receive and overlay the touch image and the first image, and generate a first combined image.

15. The image processing method as claimed in claim 14, further comprising:
receiving a touch position coordinate signal correspondingly generated when a touch operation on the touch area is performed by the input tool; and
generating the touch image according to the touch position coordinate signal.

16. The image processing method as claimed in claim 14, further comprising:
providing a third image processing unit, wherein the third image processing unit is configured to receive and transmit a second image; and
providing a second image combining unit, wherein the second image combining unit is configured to overlay the first combined image and the second image and output a second combined image.

17. The image processing method as claimed in claim 16, further comprising:
storing at least one of the first combined image and the second combined image.
